(19) United States
(12) Patent Application Publication
(10) Pub. No.: US 2023/0288814 A1
(43) Pub. Date: Sep. 14, 2023

(54) METHOD FOR SIMULATION OF NEGATIVE TONE DEVELOPMENT PHOTOLITHOGRAPHY PROCESS, NEGATIVE TONE DEVELOPMENT PHOTORESIST MODEL, OPC MODEL, AND ELECTRONIC DEVICE

(71) Applicant: Dongfang Jingyuan Electron Limited, Beijing (CN)

(72) Inventors: Li XIE, Shenzhen (CN); Shijia GAO, Shenzhen (CN)

(73) Assignee: Dongfang Jingyuan Electron Limited, Beijing (CN)

(21) Appl. No.: 18/320,226

(22) Filed: May 19, 2023

Related U.S. Application Data
(63) Continuation of application No. PCT/CN2020/133697, filed on Dec. 3, 2020.

(30) Foreign Application Priority Data
Nov. 19, 2020 (CN) 202011306691.X

(51) Int. Cl. G03F 7/20; G06F 30/20; G03F 1/36

(52) U.S. Cl. CPC G03F 7/705; G03F 7/70441; G06F 30/20; G03F 1/36

(57) ABSTRACT

The method for simulation of negative tone development photolithography process, includes following steps: S1, divide a selected photoresist region into finite elements to obtain a plurality of lattice units based on a finite element analysis method; S2, set deformation of photoresist as elastic deformation, equivalent an irradiation effect of a light field on the lattice units to a force, perform stress analysis on a lattice unit based on elastic mechanics, generate a unit stiffness matrix of each lattice unit based on a relationship between stress and strain, and form an overall stiffness matrix of the photoresist region based on generated unit stiffness matrix of each lattice unit; S3, define the stresses on nodes of each lattice unit as node forces, obtain equivalent node forces of each lattice unit, and obtain overall node forces matrix of the photoresist region based on obtained equivalent node forces; S4, solve the overall stiffness matrix and the overall node force matrix, and calculate an overall displacement of the nodes of the photoresist region based on solving results; and S5. convert the overall displacement of the nodes into light field intensity.

### CROSS-REFERENCE TO RELATED APPLICATIONS

This application claims priority to Chinese Patent Application No. 202011306691.X, disclosure of which is hereby incorporated by reference in its entireties.

### TECHNICAL FIELD

The present disclosure is related to negative tone development photolithography process technological field, and especially related to a method for simulation of negative tone development photolithography process, a negative tone development photoresist model, an OPC model, and an electronic device.

### BACKGROUND OF THE INVENTION

Lithography is the most important manufacturing process in modern large-scale integrated circuit manufacturing, which involves transferring the design patterns of integrated circuits on masks to silicon wafers through lithography machines. As a size of features gradually decrease, the process window available for manufacturing becomes smaller and smaller. The entire lithography process requires precise control, and the demand for accuracy of calculating lithography is also increasing. Accurate calculation of a lithography models is a theoretical exploration of ways to increase lithography resolution and process window, guiding optimization of process parameters.

At present, the most advanced photoresist technology is negative development technology, which differs from forward development technology in the modeling process. In forward development technology, deformation of photoresist mainly depends on distribution of acid in the photoresist after a light reaction, that is, distribution of the light field. Since an imaging optical simulation process of photolithography can be accurately calculated based on physical imaging models, it is easy to obtain more accurate results for modeling forward development photoresists. However, in negative development photoresists, due to the thermal shrinkage effect of the photoresist during a post drying process, the photoresist generates additional deformation beyond the light field distribution, which is difficult to capture. This effect is crucial for modeling negative developing photoresists, and a rigorous calculation method is urgently desired to achieve accurate modeling of negative development photoresists and to improve accuracy and practicality of existing models.

### SUMMARY OF THE INVENTION

To overcome the technical problem of poor accuracy in simulating negative development photoresist in existing lithography technologies, the present disclosure provides a method for simulation of negative development photoresist technology, a negative development photoresist model, an OPC model, and an electronic device.

In order to solve above-mentioned technological problems, the present disclosure provides a technical solution: a method for simulation of negative tone development photolithography process, which includes following steps: S1., dividing a selected photoresist region into finite elements to obtain a plurality of lattice units based on a finite element analysis method; S2, setting deformation of photoresist as elastic deformation, equating an irradiation effect of a light field on the lattice units to a force, performing stress analysis on a lattice unit based on elastic mechanics, generating a unit stiffness matrix of each lattice unit based on a relationship between stress and strain, and forming an overall stiffness matrix of the photoresist region based on generated unit stiffness matrix of each lattice unit; S3, defining the stresses on nodes of each lattice unit as node forces, obtaining equivalent node forces of each lattice unit, and obtaining overall node forces matrix of the photoresist region based on obtained equivalent node forces; S4, solving the overall stiffness matrix and the overall node force matrix, and calculating an overall displacement of the nodes of the photoresist region based on solving results; and S5, converting the overall displacement of the nodes into light field intensity.

Preferably, the unit stiffness matrix obtained in step S2 is as follow:

$$[ {k}_{ij} ] = \frac{E * h}{4 * ( 1 - {μ}^{2} )} * [ \begin{matrix}\begin{matrix}{ε}_{i} {ε}_{j} * ( 1 + \frac{1}{3} {η}_{i} {η}_{j} ) + \\ \frac{1 - μ}{2} {η}_{i} {η}_{j} ( 1 + \frac{1}{3} {ε}_{i} {ε}_{j} )\end{matrix} & μ {ε}_{i} {η}_{j} + \frac{1 - μ}{2} {η}_{i} {ε}_{j} \\ μ {η}_{i} {ε}_{j} + \frac{1 - μ}{2} {ε}_{i} {η}_{j} & \begin{matrix}{η}_{i} {η}_{j} * ( 1 + \frac{1}{3} {ε}_{i} {ε}_{j} ) + \\ \frac{1 - μ}{2} {ε}_{i} {ε}_{j} ( 1 + \frac{1}{3} {η}_{i} {η}_{j} )\end{matrix}\end{matrix} ]$$

wherein, F is Young's modulus; μ is Poisson ratio; εᵢ, ηⱼ are respectively coordinates of a node on two different directions; h is a thickness of a lattice unit; kᵢⱼ is a stiffness coefficient corresponding to the node coordinates.

Preferably, step S4 includes: S41, set boundary conditions to solve the overall stiffness matrix and the overall node force matrix; and S42, calculate the overall displacement of the nodes based on the overall stiffness matrix and the overall node force matrix using the following Preferably, step S41 includes: calculating a unit stiffness matrix for each lattice unit and then obtaining the overall stiffness matrix through a Finite Element Analysis (FEA) method; and calculating an equivalent node force for each lattice unit and then obtaining the overall node force matrix through a Finite Element Analysis (FEA) method.

Preferably, each lattice unit is in a square shape, and a range of a length of sides is 3˜10 nm.

Preferably, in step S5, converting the overall displacement of the nodes into light field intensity is based on a linear interpolation method, step S5 includes following steps: S51, obtain an original distance tween two nodes and an original light field intensity of each node; and S52, set the original light field intensity of the nodes of each lattice unit to remain unchanged, and a distance between lattice units changes as the node displacement moves. Calculate a derivative of a light field difference and a displacement difference between two nodes, and multiply the derivative by the original distance between the two nodes to obtain a new light field intensity.

Preferably, the method further includes the following step: S6, calculating the Young's modulus E and the Poisson's ratio using a solver.

In order to solve above-mentioned technological problems, the present disclosure further provides a method for creating a negative tone development photoresist model, which includes the method for simulation of negative tone development photolithography process and the following step: S7, creating the negative tone development photoresist model based on the light field intensity obtained in step S5 as a variable, wherein the light field distribution is set to E(x, y), and the distribution of acid concentration in the photoresist is set as a function of the light field distribution, that is, S(x, y)=F(E(x, y)).

In order to solve above-mentioned technological problems, the present disclosure further provides a method for creating an OPC model, which includes: providing an initial OPC model and adding the negative tone development photoresist model.

In order to solve above-mentioned technological problems, the present disclosure further provides an electronic device, which includes one or more processors, a storage device configured to storing one or more programs, when the one or more programs is executed by the one or more processors, the one or more processors are caused to perform the method.

Comparing with existing technologies, S1, divide a selected photoresist region into finite elements to obtain a plurality of lattice units based on a finite element analysis method; S2, set deformation of photoresist as elastic deformation, equivalent an irradiation effect of a light field on the lattice units to a force, perform stress analysis on a lattice unit based on elastic mechanics, generate a unit stiffness matrix of each lattice unit based on a relationship between stress and strain, and form an overall stiffness matrix of the photoresist region based on generated unit stiffness matrix of each lattice unit; S3, define the stresses on nodes of each lattice unit as node forces, obtain equivalent node forces of each lattice unit, and obtain overall node forces matrix of the photoresist region based on obtained equivalent node forces; S4, solve the overall stiffness matrix and the overall node force matrix, and calculate an overall displacement of the nodes of the photoresist region based on solving results; and S5. convert the overall displacement of the nodes into light field intensity. Using the finite element analysis method to analyze the selected photoresist region and equating the effect of the light field on the photoresist with a form of force can effectively analyze the deformation of the photoresist during the thermal shrinkage effect process, improving accuracy of the lithography calculation process. At the same time, using the finite element analysis method to perform equivalent analysis on the selected photoresist region can improve calculation speed and accuracy.

In step S4, S4 specifically includes the following steps:

S41, set boundary conditions to solve the overall stiffness matrix and the overall node force matrix; and S42, calculate the overall displacement of the nodes based on the overall stiffness matrix and the overall node force matrix using the following formula: overall stiffness matrix*overall displacement of the nodes=overall node force matrix. Since the overall stiffness matrix is a singular matrix, appropriate boundary conditions are set to solve the overall stiffness matrix, which can obtain more accurate results.

The negative tone development photoresist model, the OPC model and the electronic device provided by the present disclosure has the same technological effects with above mentioned technological effects.

### BRIEF DESCRIPTION OF DRAWINGS

FIG. 1 is a flow chart of a method for simulation of negative tone development photolithography process according to a first embodiment of the present disclosure.

FIG. 2 is a detailed flow chart of step S4 in the method for simulation of negative tone development photolithography process according to the first embodiment of the present disclosure.

FIG. 3 is a detailed flow chart of step S5 in the method for simulation of negative tone development photolithography process according to the first embodiment of the present disclosure.

FIG. 4 is a flow chart of a method for simulation of negative tone development photolithography process according to a variation of the first embodiment of the present disclosure.

FIG. 5 is a block diagram of an electronic device according to a fourth embodiment of the present disclosure.

FIG. 6 is a schematic view of a computer system for implementing the present disclosure.

### DETAILED DESCRIPTION OF THE INVENTION

In order to make the objects, technical solutions and advantages of the invention clearer, the invention will be further described in detail in combination with the drawings and the embodiments. It should be understood that the embodiments described herein are only used to explain the invention and are not used to limit the invention.

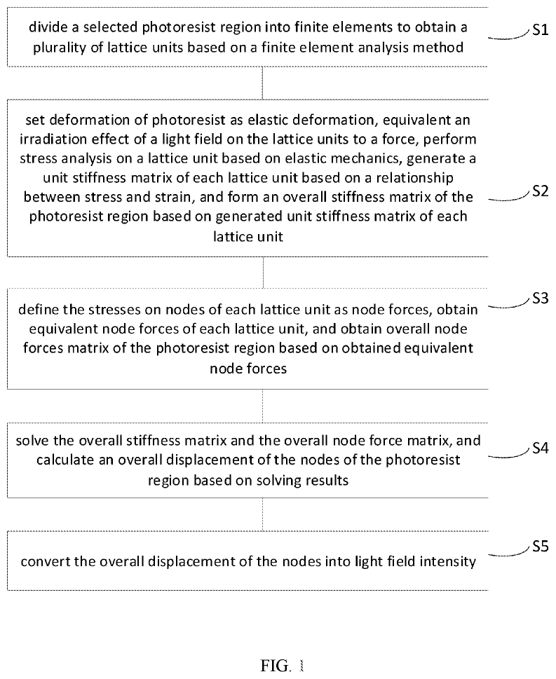

Referring to FIG. 1, a first embodiment of the present disclosure provides a method for simulation of negative tone development photolithography process, the method includes following steps:

S1, divide a selected photoresist region into finite elements to obtain a plurality of lattice units based on a finite element analysis method;

S2, set deformation of photoresist as elastic deformation, equivalent an irradiation effect of a light field on the lattice units to a force, perform stress analysis on a lattice unit based on elastic mechanics, generate a unit stiffness matrix of each lattice unit based on a relationship between stress and strain, and form an overall stiffness matrix of the photoresist region based on generated unit stiffness matrix of each lattice unit;

S3, define the stresses on nodes of each lattice unit as node forces, obtain equivalent node forces of each lattice unit, and obtain overall node forces matrix of the photoresist region based on obtained equivalent node forces;

S4, solve the overall stiffness matrix and the overall node force matrix, and calculate an overall displacement of the nodes of the photoresist region based on solving results; and

S5. convert the overall displacement of the nodes into light field intensity.

Negative development technology is a type of development technology with image inverted, which is opposite to traditional development technologies. By using special organic solvents for development, negative images can be obtained using traditional positive photoresists. Photoresist compositions used in this technology include resin and photoacid generator, in which the resin has acid unstable groups or acid cleavable organic groups. In the post exposure bake, exposed area is subjected to an action of acid generated by the light on the photoacid generator, causing the unstable groups or the acid cleavable groups in the resin to break to make the exposed area to be change from hydrophobicity to hydrophilicity, thereby reducing solubility of the exposed area in organic solvents. However, unexposed area still maintains its high solubility in the organic solvents, which allows them to be removed from the development solution made from the organic solvents during the development process. Therefore, contrary to dissolution of the exposed area during the development process of the traditional positive photoresist, this technology allows the unexposed area of the positive photoresist to be dissolved during development process, while the exposed area is retained. Therefore, it can be known that distribution and a shape of the image after exposure are directly related to distribution of acid, which is directly related to distribution of the light field,

In step S1, the lattice unit is in a square shape, a range of a length of sides is 3˜10 nm. Optionally, a range of the length of sides can be 4˜8 nm or 5˜6 nm; Optionally, a range of the length of sides can be: 3.5 nm, 4.5 nm, 5.5 nm, 7.5 nm or 8.5 nm. As an example, a size of the selected photoresist region is 800 nm˜1200 nm. An image resolution is 200*200. Therefore, each plane of each lattice unit has four nodes.

Referring to FIG. 1 again, the method for simulation of negative tone development photolithography process further includes following step:

S2, set deformation of photoresist as elastic deformation, equivalent an irradiation effect of a light field on the lattice units to a force, perform stress analysis on a lattice unit based on elastic mechanics, generate a unit stiffness matrix of each lattice unit based on a relationship between stress and strain, and form an overall stiffness matrix of the photoresist region based on generated unit stiffness matrix of each lattice unit.

In this step, the photoresist can be a resin material containing high polymers, which has a certain degree of elasticity. Therefore, it can be considered as an elastic material with a certain degree of elasticity, and the thermal shrinkage effect of the photoresist during post exposure bake process can be considered as elastic deformation. Since the elastic deformation of the photoresist is mainly due to irradiation of the light filed, the irradiation of the light field on the lattice units can be considered as a shape of a force. Performing stress analysis on the lattice units based on elastic mechanics to generate a unit stiffness matrix of each lattice unit based on a relationship between stress and strain can obtain an overall stiffness matrix of the photoresist region based on generated unit stiffness matrix of each lattice unit.

In this step, generation of the unit stiffness matrix of each lattice unit based on a relationship between stress and strain is according to existing elastic mechanics formulas. Therefore, detailed generation process will not illustrated here. The unit stiffness matrix obtained in step S2 is as follow:

$$[ {k}_{ij} ] = \frac{E * h}{4 * ( 1 - {μ}^{2} )} * [ \begin{matrix}\begin{matrix}{ε}_{i} {ε}_{j} * ( 1 + \frac{1}{3} {η}_{i} {η}_{j} ) + \\ \frac{1 - μ}{2} {η}_{i} {η}_{j} ( 1 + \frac{1}{3} {ε}_{i} {ε}_{j} )\end{matrix} & μ {ε}_{i} {η}_{j} + \frac{1 - μ}{2} {η}_{i} {ε}_{j} \\ μ {η}_{i} {ε}_{j} + \frac{1 - μ}{2} {ε}_{i} {η}_{j} & \begin{matrix}{η}_{i} {η}_{j} * ( 1 + \frac{1}{3} {ε}_{i} {ε}_{j} ) + \\ \frac{1 - μ}{2} {ε}_{i} {ε}_{j} ( 1 + \frac{1}{3} {η}_{i} {η}_{j} )\end{matrix}\end{matrix} ]$$

Wherein, E is Young's modulus; μ is Poisson ratio; εᵢ, ηⱼ are respectively coordinates of a node on two different directions; h is a thickness of a lattice unit; kᵢⱼ is a stiffness coefficient corresponding to the node coordinates.

Referring to FIG. 1 again, the method for simulation of negative tone development photolithography process further includes following step:

S3, define the stresses on nodes of each lattice unit as node forces, obtain equivalent node forces of each lattice unit, and obtain overall node force matrix of the photoresist region based on obtained equivalent node forces.

In this step, acquisition of equivalent node forces and acquisition of the overall node forces matrix are relatively mature technologies in existing finite element analysis methods, so they will not be described in detail here.

Referring to FIG. 1 again, the method for simulation of negative tone development photolithography process further includes following step:

S4, solve the overall stiffness matrix and the overall node force matrix, and calculate an overall displacement of the nodes of the photoresist region based on solving results.

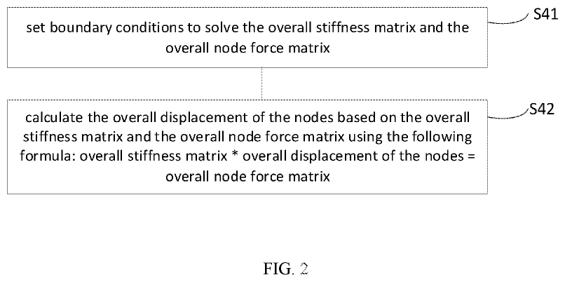

Referring to FIG. 2, step S4 specifically includes following steps:

S41, set boundary conditions to solve the overall stiffness matrix and the overall node force matrix; and

S42, calculate the overall displacement of the nodes based on the overall stiffness matrix and the overall node force matrix using the following formula:

overall stiffness matrix*overall displacement of the nodes=overall node force matrix.

In step S41, since the overall stiffness matrix is a singular matrix, appropriate boundary conditions are needed to be set to solve the overall stiffness matrix. Setting of the boundary conditions can be based on actual physical properties of the photoresist or by selecting some boundary setting methods, such as perfect matched layer (PML).

Detailed process of step S41 is as follow:

A solving process of the overall stiffness matrix is: calculate a unit stiffness matrix for each lattice unit and then obtain the overall stiffness matrix through a Finite Element Analysis (FEA) method.

A solving process of the overall node force matrix is: calculate an equivalent node force for each lattice unit and then obtain the overall node force matrix through a Finite Element Analysis (FEA) method.

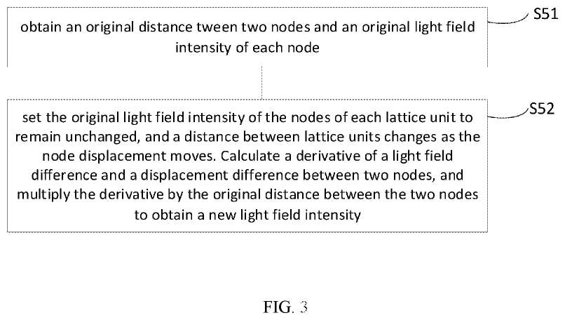

Referring to FIG. 3, in step S5, convert the overall displacement of the nodes into light field intensity through a linear interpolation method. Step S5 specifically includes following steps:

S51, obtain an original distance tween two nodes and an original light field intensity of each node; and

S52, set the original light field intensity of the nodes of each lattice unit to remain unchanged, and a distance between lattice units changes as the node displacement moves. Calculate a derivative of a light field difference and a displacement difference between two nodes, and multiply the derivative by the original distance between the two nodes to obtain a new light field intensity.

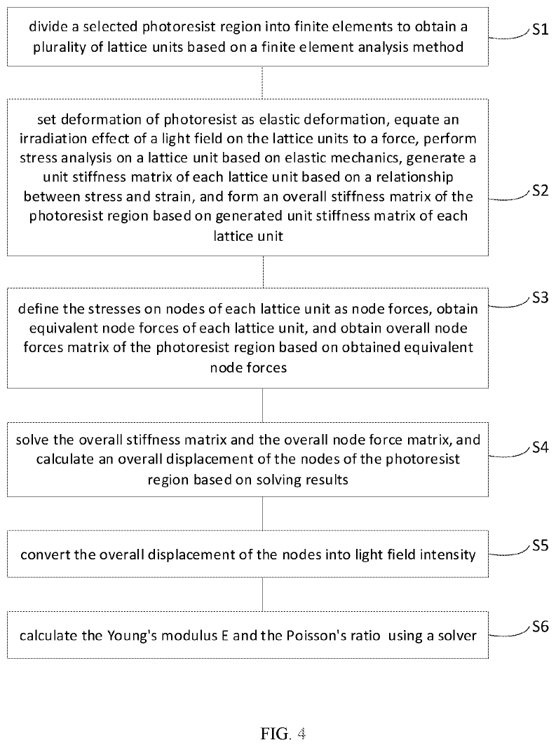

Referring to FIG. 4, the method for simulation of negative tone development photolithography process further includes following step: S6, calculate the Young's modulus E and the Poisson's ratio μ using a solver.

Specifically, the Young's modulus E and the Poisson's ratio μ can be calculated using a solver named as “solver”.

A second embodiment of the present disclosure provides a negative tone development photoresist model, which can be obtained through the method for simulation of negative tone development photolithography process provided by the first embodiment of the present disclosure and the following step: S7, based on the light field intensity obtained in step S5 as a variable, a negative tone development photoresist model is established. The light field distribution is set to E(x, y), and the distribution of acid concentration in the photoresist is set as a function of the light field distribution, that is, S(x, y)=F(E(x, y)).

A third embodiment of the present disclosure provides an OPC model, which includes an initial OPC model and the negative tone development photoresist model provided by the second embodiment. Generally, the initial OPC model includes a background light intensity distribution function, a light intensity gradient function, a light intensity curve function, a photo base distribution function, and a photoacid distribution function. After adding the negative tone development photoresist model mentioned above, it can adapt well to the negative photoresist process, simulate and calculate the thermal shrinkage effect of the negative photoresist, and improve accuracy of the lithography process.

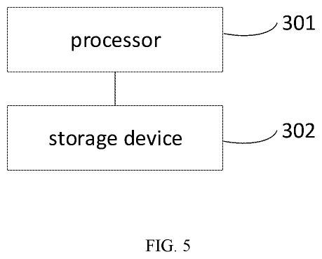

Referring to FIG. 5, a second embodiment of the present disclosure provides an electronic device 300, which includes one or more processors 301;

A storage device 302 configured to store one or more programs;

When the one or more programs are executed by the one or more processors 301, the one or more processors 301 are caused to perform the method for simulation of negative tone development photolithography process provided by the first embodiment.

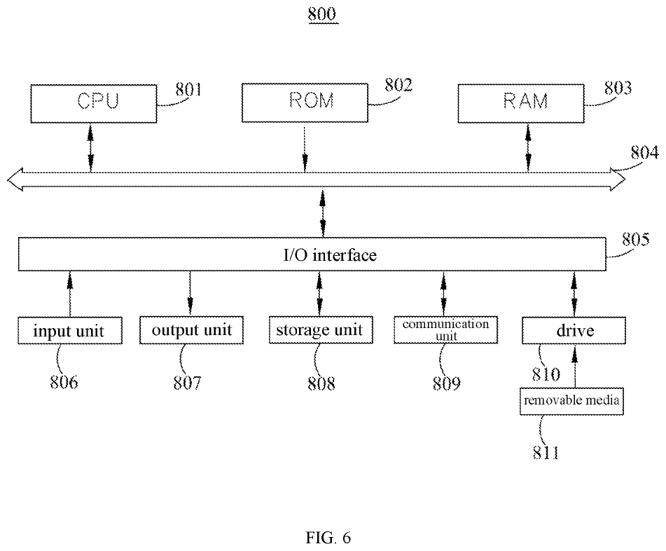

Referring to FIG. 6, a structural diagram of a computing system 800 for implementing a terminal device server (eg. the electronic device 300) is illustrated. The terminal device/server shown in FIG. 6 is only an example and should not impose any limitations on functionality and scope of use of the present disclosure.

Referring to FIG. 6, the computing system 800 includes a central processing unit (CPU) 801, which can perform various appropriate actions and processing based on programs stored in a read-only memory (ROM) 802 or programs loaded from a storage unit 808 into a random access memory (RAM) 803. In the RAM 803, various programs and data required for operations of the system 800 are also stored. The CPU 801, the ROM 802, and the RAM 803 are connected to each other through a bus 804. An input/output (I/O) interface 805 is also connected to the bus 804.

The following components are connected to the I/O interface 805: an input unit 806 including a keyboard, a mouse, and etc.; an output unit 807 including a cathode ray tube (CRT), a liquid crystal display (LCD), a speaker, and etc.; a storage unit 808 including a hard disk, and etc.; and a communication unit 809 including network interface cards such as LAN cards, modems, etc. The communication unit 809 performs communication processing through a network such as the Internet. A drive 810 is also connected to the I/O interface 805 as needed. A removable media 811, such as magnetic disks, optical disks, magneto-optical disks, semiconductor memory, etc., are installed on the drive 810 as needed to facilitate installation of computer programs read from it into the storage unit 808 as needed.

According to the embodiments of the present disclosure, the processes described in above methods may be implemented as a computer software program. For example, embodiments of the present disclosure include a computer program product that includes a computer program carried on a computer-readable medium. The computer program includes program codes for executing a method shown in a flow chart. In such an embodiment, the computer program may be downloaded and installed from the network through a communication unit 809, and/or installed from a removable medium 811. When the computer program is executed by the central processing unit (CPU) 801, the above functions defined in the methods of the present disclosure are executed. It should be noted that the computer-readable medium described in the present disclosure can be a computer-readable signal medium or a computer-readable storage medium or any combination of the two. Computer readable storage medium can include, but is not limited to, systems, devices or components including, but not limited to, electrical, magnetic, optical, electromagnetic, infrared, or semiconductor, or any combination of the above. More detailed examples of computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combination of the above.

The computer program codes for performing the operations of the present disclosure can be written in one or more programming languages or a combination thereof. The programming languages include object-oriented programming languages such as Java, Smalltalk, C++, and conventional procedural programming languages such as “C” or similar programming languages. The program codes can be completely executed on a user's computer, partially executed on the user's computer, executed as an independent software package, partially executed on the user's computer, partially executed on a remote computer, or completely executed on the remote computer or a server. In the case involving a remote computer, the remote computer may be connected to the user computer through any kind of networks, including a local area network (LAN) or a wide area network (WAN), or may be connected to an external computer (e.g., through the Internet using an Internet service provider).

The flow charts and module diagrams in the attached drawings illustrate possible architectures, functions and operations of systems, methods and computer program products according to various embodiments of the present application. In this regard, each block in a flow chart or a block diagram may represent a module, program segment, or part of code that contains one or more executable instructions for implementing a specified logical function. It should also be noted that in some alternative embodiments, functions identified in the blocks may also occur in a different order than those shown in the drawings. For example, two blocks represented successively can actually be executed basically in parallel, and they can sometimes be executed in an opposite order, depending on functions involved. It should also be noted that each block in the block diagram and/or a flow chart and the combination of blocks in the block diagram and/or the flow chart can be realized by a dedicated hardware based system performing specified functions or operations, or by a combination of dedicated hardware and computer instructions.

The above computer readable medium stores one or more programs, when the one or more programs are executed by the device, the device is caused to perform the following steps S1, divide a selected photoresist region into finite elements to obtain a plurality of lattice units based on a finite element analysis method; S2, set deformation of photoresist as elastic deformation, equivalent an irradiation effect of a light field on the lattice units to a force, perform stress analysis on a lattice unit based on elastic mechanics, generate a unit stiffness matrix of each lattice unit based on a relationship between stress and strain, and form an overall stiffness matrix of the photoresist region based on generated unit stiffness matrix of each lattice unit; S3, define the stresses on nodes of each lattice unit as node forces, obtain equivalent node forces of each lattice unit, and obtain overall node forces matrix of the photoresist region based on obtained equivalent node forces; S4, solve the overall stiffness matrix and the overall node force matrix, and calculate an overall displacement of the nodes of the photoresist region based on solving results; and S5. convert the overall displacement of the nodes into light field intensity.

Comparing with existing technologies, S1, divide a selected photoresist region into finite elements to obtain a plurality of lattice units based on a finite element analysis method; S2, set deformation of photoresist as elastic deformation, equivalent an irradiation effect of a light field on the lattice units to a force, perform stress analysis on a lattice unit based on elastic mechanics, generate a unit stiffness matrix of each lattice unit based on a relationship between stress and strain, and form an overall stiffness matrix of the photoresist region based on generated unit stiffness matrix of each lattice unit; S3, define the stresses on nodes of each lattice unit as node forces, obtain equivalent node forces of each lattice unit, and obtain overall node forces matrix of the photoresist region based on obtained equivalent node forces; S4, solve the overall stiffness matrix and the overall node force matrix, and calculate an overall displacement of the nodes of the photoresist region based on solving results; and S5, convert the overall displacement of the nodes into light field intensity. Using the finite element analysis method to analyze the selected photoresist region and equating the effect of the light field on the photoresist with a form of force can effectively analyze the deformation of the photoresist during the thermal shrinkage effect process, improving accuracy of the lithography calculation process. At the same time, using the finite element analysis method to perform equivalent analysis on the selected photoresist region can improve calculation speed and accuracy.

In step S4, S4 specifically includes the following steps:

S41, set boundary conditions to solve the overall stiffness matrix and the overall node force matrix; and S42, calculate the overall displacement of the nodes based on the overall stiffness matrix and the overall node force matrix using the following formula: overall stiffness matrix*overall displacement of the nodes=overall node force matrix. Since the overall stiffness matrix is a singular matrix, appropriate boundary conditions are set to solve the overall stiffness matrix, which can obtain more accurate results.

The negative tone development photoresist model, the OPC model and the electronic device provided by the present disclosure has the same technological effects with above mentioned technological effects.

The above description are only embodiments of the present disclosure, and is not intended to limit the present disclosure. Any modifications, equivalent substitutions, improvements, etc. made within the spirit and scope of the present disclosure are intended to be included within the scope of the present disclosure.

What is claimed is:

1. A method for simulation of negative tone development photolithography process, comprising following steps:
S1, dividing a selected photoresist region into finite elements to obtain a plurality of lattice units based on a finite element analysis method;
S2, setting deformation of photoresist as elastic deformation, equating an irradiation effect of a light field on the lattice units to a force, performing stress analysis on a lattice unit based on elastic mechanics, generating a unit stiffness matrix of each lattice unit based on a relationship between stress and strain, and forming an overall stiffness matrix of the photoresist region based on generated unit stiffness matrix of each lattice unit;
S3, defining the stresses on nodes of each lattice unit as node forces, obtaining equivalent node forces of each lattice unit, and obtaining overall node forces matrix of the photoresist region based on obtained equivalent node forces;
S4, solving the overall stiffness matrix and the overall node force matrix, and calculating an overall displacement of the nodes of the photoresist region based on solving results; and
S5, converting the overall displacement of the nodes into light field intensity.

2. The method for simulation of negative tone development photolithography process according to claim 1, wherein the unit stiffness matrix obtained in step S2 is as follow:
$$[ {k}_{ij} ] = \frac{E * h}{4 * ( 1 - {μ}^{2} )} * [ \begin{matrix}\begin{matrix}{ε}_{i} {ε}_{j} * ( 1 + \frac{1}{3} {η}_{i} {η}_{j} ) + \\ \frac{1 - μ}{2} {η}_{i} {η}_{j} ( 1 + \frac{1}{3} {ε}_{i} {ε}_{j} )\end{matrix} & μ {ε}_{i} {η}_{j} + \frac{1 - μ}{2} {η}_{i} {ε}_{j} \\ μ {η}_{i} {ε}_{j} + \frac{1 - μ}{2} {ε}_{i} {η}_{j} & \begin{matrix}{η}_{i} {η}_{j} * ( 1 + \frac{1}{3} {ε}_{i} {ε}_{j} ) + \\ \frac{1 + μ}{2} {ε}_{i} {ε}_{j} ( 1 + \frac{1}{3} {η}_{i} {η}_{j} )\end{matrix}\end{matrix} ]$$
wherein, E is Young's modulus; μ is Poisson ratio; εᵢ, ηⱼ are respectively coordinates of a node on two different directions; h is a thickness of a lattice unit; kᵢⱼ is a stiffness coefficient corresponding to the node coordinates,

3. The method for simulation of negative tone development photolithography process according to claim 2, wherein step S4 comprises:
S41, set boundary conditions to solve the overall stiffness matrix and the overall node force matrix; and
S42, calculate the overall displacement of the nodes based on the overall stiffness matrix and the overall node force matrix using the following formula: overall stiffness matrix*overall displacement of the nodes=overall node force matrix.

4. The method for simulation of negative tone development photolithography process according to claim 3, wherein step S41 comprises:
calculating a unit stiffness matrix for each lattice unit and then obtaining the overall stiffness matrix through a Finite Element Analysis (FEA) method; and
calculating an equivalent node force for each lattice unit and then obtaining the overall node force matrix through a Finite Element Analysis (FEA) method.

5. The method for simulation of negative tone development photolithography process according to claim 1, wherein each lattice unit is in a square shape, and a range of a length of sides is 3˜10 nm.

6. The method for simulation of negative tone development photolithography process according to claim 1, wherein, in step S5, converting the overall displacement of the nodes into light field intensity is based on a linear interpolation method, step S5 comprises following steps:
S51, obtain an original distance tween two nodes and an original light field intensity of each node; and
S52, set the original light field intensity of the nodes of each lattice unit to remain unchanged, and a distance between lattice units changes as the node displacement moves. Calculate a derivative of a light field difference and a displacement difference between two nodes, and multiply the derivative by the original distance between the two nodes to obtain a new light field intensity.

7. The method for simulation of negative tone development photolithography process according to claim 2, wherein the method further comprises the following step:
S6, calculating the Young's modulus E and the Poisson's ratio using a solver.

8. A method for creating a negative tone development photoresist model, comprising the method for simulation of negative tone development photolithography process of claim 1 and the following step:
S7, creating the negative tone development photoresist model based on the light field intensity obtained in step S5 as a variable, wherein the light field distribution is set to E(x, y), and the distribution of acid concentration in the photoresist is set as a function of the light field distribution, that is, S(x, y)=F(E(x, y)).

9. A method for creating an OPC model, comprising: providing an initial OPC model and adding the negative tone development photoresist model of claim 8,

10. An electronic device, comprising:
one or more processors;
a storage device, configured to store one or more programs;
when the one or more programs are executed by the one or more processors, the one or more processors are caused to perform the method for simulation of negative tone development photolithography process of claim 1.
